(19) United States
(12) Patent Application Publication
(10) Pub. No.: US 2016/0180311 A1
(43) Pub. Date: Jun. 23, 2016

(54) SYSTEM AND METHOD FOR GENERATING AN ORDERING MENU

(71) Applicant: David Tung, Sunnyvale, CA (US)

(72) Inventor: David Tung, Sunnyvale, CA (US)

(21) Appl. No.: 14/972,090

(22) Filed: Dec. 17, 2015

Related U.S. Application Data
(60) Provisional application No. 62/094,380, filed on Dec. 19, 2014.

(51) Int. Cl. G06Q 20/20; G06Q 30/06; G06Q 50/12

(52) U.S. Cl. CPC G06Q 20/20; G06Q 50/12; G06Q 30/0607

(57) ABSTRACT

System and method for creating an ordering menu for food and/or beverage items from point of sale (POS) data obtains the POS data from at least one food and/or beverage venue by a server, select a subset of the POS data based on a menu generation policy by the server and generate the ordering menu for the at least one food and/or beverage venue from the subset of POS data by the server.

### REFERENCE TO RELATED APPLICATIONS

This application claims the benefit of U.S. Provisional Patent Application 62/094,380 filed on Dec. 19, 2014 and entitled “Method to Generate Ordering Menu from Point of Sales Systems,” which is hereby incorporated by reference.

### BACKGROUND

In order to allow customers to order items, restaurant or other food business owners need to create ordering menus in paper form (e.g., as printed menus) or in electronic form (e.g., as web pages). However, ordering menus are typically created from scratch in a tedious and error-prone process. For example, a restaurant owner may need to hire a professional to manually create an ordering menu, which increases the expenditure of the restaurant and reduces the profitability of the restaurant. Alternatively, a restaurant owner may have to spend his/her own time to manually create an ordering menu, which reduces the productivity of the restaurant owner and the profitability of the restaurant, even though item information is available in a point of sale (POS) system. One reason an ordering menu cannot be easily created from available POS data is that the information stored in a POS system is usually a mix of valid (up to date) data and out of date data since business owners usually do not spend time on cleaning the POS data. Because POS data is typically a mix of up to date data and out of date data, it is difficult to create an accurate/up-to-date ordering menu directly from a POS database. Consequently, ordering menus are typically created manually in a tedious and error-prone manual process. Therefore, there is a need for creating an ordering menu from POS data without a tedious and error-prone manual process.

### SUMMARY

System and method for creating an ordering menu for food and/or beverage items from POS data obtains the POS data from at least one food and/or beverage venue by a server, select a subset of the POS data based on a menu generation policy by the server and generate the ordering menu for the at least one food and/or beverage venue from the subset of POS data by the server.

In an embodiment, a method of creating an ordering menu for food and/or beverage items from POS data involves obtaining the POS data from at least one food and/or beverage venue by a server, selecting a subset of the POS data based on a menu generation policy by the server and generating the ordering menu for the at least one food and/or beverage venue from the subset of POS data by the server.

In an embodiment, a system of creating an ordering menu for food and/or beverage items from POS data includes a POS data receiver configured to obtain the POS data from at least one food and/or beverage venue by a server, a POS data selector configured to select a subset of the POS data based on a menu generation policy by the server and an ordering menu generator configured to generate the ordering menu for the at least one food and/or beverage venue from the subset of POS data by the server.

In an embodiment, a computer-readable storage medium containing program instructions for creating an ordering menu for food and/or beverage items from POS data. Execution of the program instructions by one or more processors causes the one or more processors to perform steps, which include obtaining the POS data from at least one food and/or beverage venue by a server, selecting a subset of the POS data based on a menu generation policy by the server, and generating the ordering menu for the at least one food and/or beverage venue from the subset of POS data by the server.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of an ordering menu generation system in accordance with an embodiment of the invention.

FIG. 2 depicts an embodiment of a POS server of the ordering menu generation system depicted in FIG. 1.

FIG. 3 depicts an embodiment of a POS ordering interface of the POS server depicted in FIG. 2.

FIG. 4 is a flow chart that illustrates an exemplary operation of an intelligent POS menu generation server of the ordering menu generation system depicted in FIG. 1.

FIG. 5 depicts an example of an ordering menu.

FIG. 6 depicts an example of an ordering menu after enhancement operations.

FIG. 7 shows a result data set of an example enhancement operation.

FIG. 8 is a block diagram of the intelligent POS menu generation server of the ordering menu generation system depicted in FIG. 1 in accordance with an embodiment of the invention.

FIG. 9 is a flow diagram of a method for creating an ordering menu for food and/or beverage items from POS data in accordance with an embodiment of the invention.

FIG. 10 is a block diagram of a server of the ordering menu generation system depicted in FIG. 1 in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

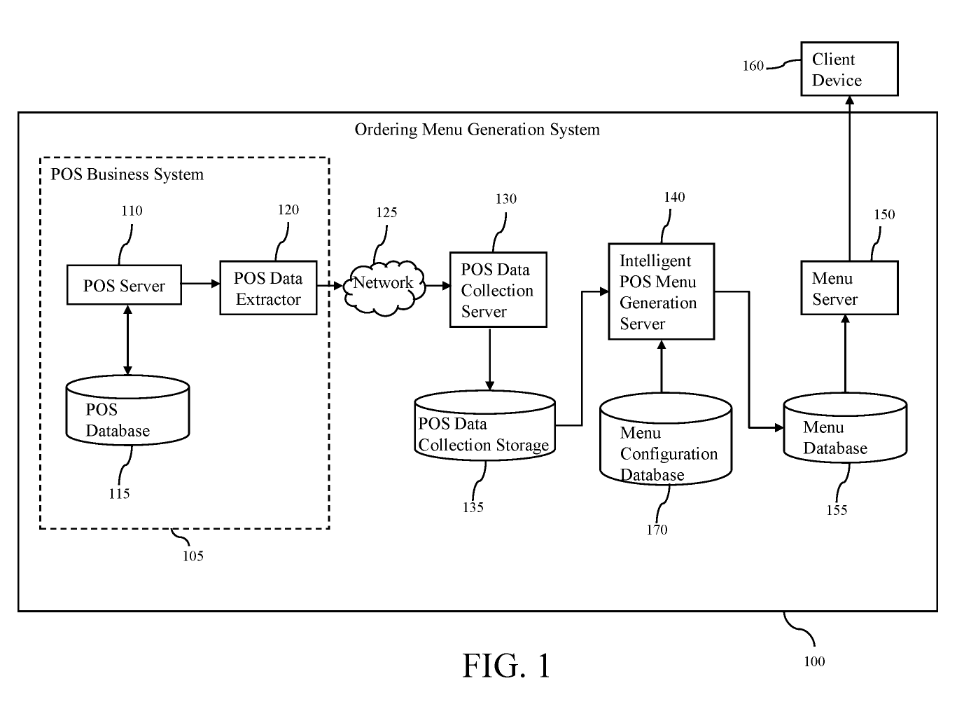

Turning now to FIG. 1, an ordering menu generation system 100 in accordance with an embodiment of the invention is shown. In the embodiment depicted in FIG. 1, the ordering menu generation system includes a point of sale (POS) server 110, a POS database (DB) 115, a POS data extractor 120, a network 125, a POS data collection server 130, a POS data collection storage 135, an intelligent POS menu generation server 140, a menu generation configuration database 170, a menu database 155 and a menu server 150. Although the ordering menu generation system is shown in FIG. 1 as including certain components, in some embodiments, the ordering menu generation system includes less or more components to implement less or more functionalities. For example, in some embodiments, the ordering menu generation system does not include the POS data collection server and the POS data collection storage. In these embodiments, the intelligent POS menu generation server receives POS data directly from the POS data extractor.

One reason an ordering menu cannot be easily created from available POS data is that the information stored in a POS system is usually a mix of valid (up to date) data and out of date data since business owners usually do not spend time on cleaning the POS data. Because POS data is typically a mix of up to date data and out of date data, it is difficult to create an accurate/up-to-date ordering menu directly from a POS database. The ordering menu generation system can select menu information from POS data and generate an accurate/up-to-date ordering menu in paper form (e.g., as printed menus) or in electronic form (e.g., as web pages) for customers, as further described below.

In the ordering menu generation system 100 depicted FIG. 1, the POS server 110 is configured to gather food, beverage and/or other service/goods items order information at one or more food and/or beverage venues, such as restaurants (standalone restaurant and affiliated restaurants, e.g., restaurants within hotels or other businesses), cafeterias, bars, food trucks, and food stands. In some embodiments, the POS server is a cloud POS server that remotely collects and processes food and beverage order information to generate POS data. In other embodiments, the POS server is installed at a checkout location (e.g., a checkout counter) of a restaurant or other food business, in order to record the sale of food items, beverage items or other service/goods items. The POS server may include a display device, a processor, memory, an input device, a printing device, a power interface, a power management device and/or a network interface device. The input device may be a standalone device (e.g., a keyboard) or is integrated within the display device (e.g., a touch screen device). In some embodiments, the POS server is implemented as a POS terminal. In the embodiment depicted in FIG. 1, the POS server stores and/or retrieves POS data in the POS database 115.

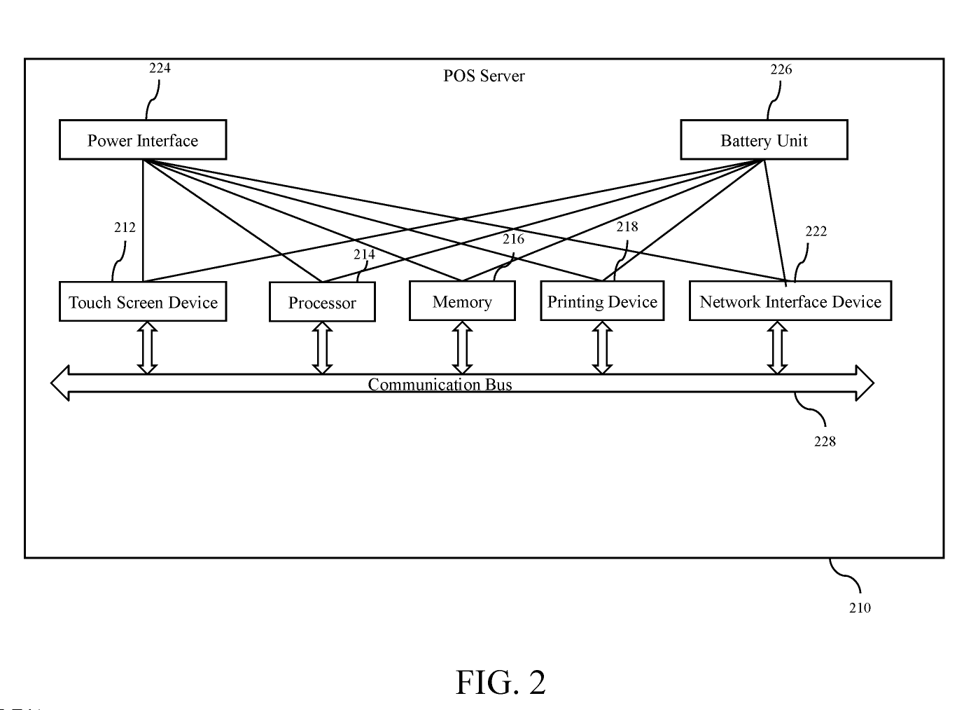

FIG. 2 depicts an embodiment of the POS server 110 of the ordering menu generation system 100. The POS server 210 depicted in FIG. 2 is one possible embodiment of the POS server 110 depicted in FIG. 1. However, the POS server depicted in FIG. 1 is not limited to the embodiment shown in FIG. 2.

In the embodiment depicted in FIG. 2, the POS server 110 includes a touch screen device 212, a processor 214, memory 216, an optional printing device 218, a network interface 222, a power interface 224 and a battery unit 226. The touch screen device is configured to display a POS interface and receive inputs to the POS interface. The processor is configured to process inputs to the POS interface and to generate order information for food and/or beverage items. In some embodiments, the POS server includes a payment processing interface and the processor is configured to process payments for food and/or beverage orders. The memory is configured to store the inputs to the POS interface and/or the generated order information. The print device is configured to print orders for food and/or beverage items. The network interface device is configured to provide a wired communication interface and/or a wireless communication interface for the POS server. The power interface, which may be an Alternating Current (AC) power interface, is used to supply power to the POS server. The battery unit, which may be any suitable type of battery unit (e.g., one or more alkaline batteries and lithium-ion batteries), may be used to supply backup power to the POS server. In the embodiment depicted in FIG. 2, the touch screen device, the processor, the memory, the printing device and the network interface are all connected to a communication bus 228, which facilitates communications between these connected devices. However, in other embodiments, at least some of the touch screen device, the processor, the memory, the printing device and the network interface are not connected to the communication bus and communicate with other component of the POS server through other communication connections.

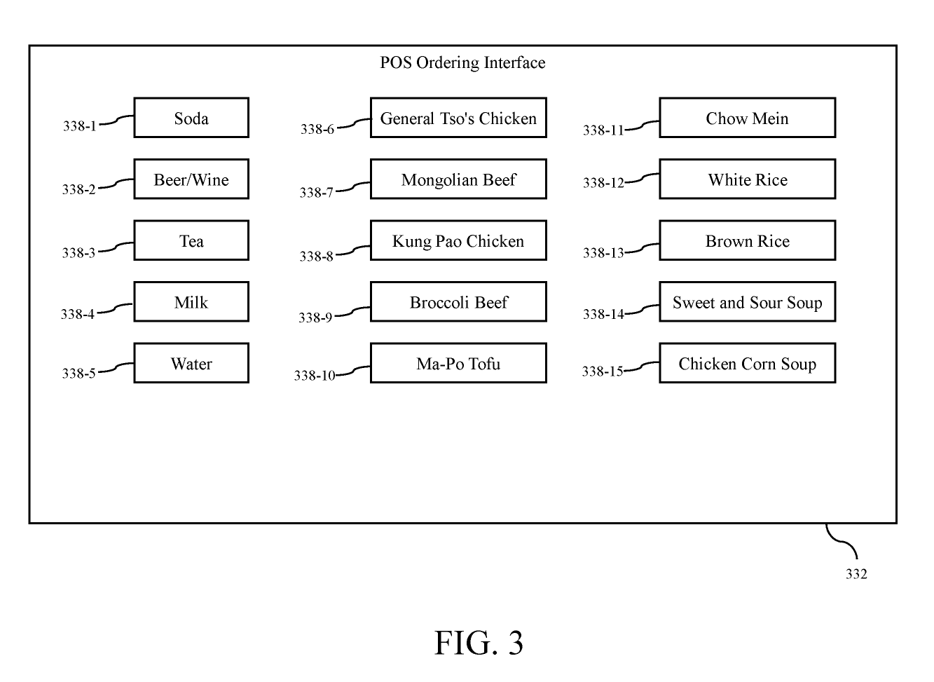

FIG. 3 depicts an embodiment of a POS ordering interface of the POS server 210 depicted in FIG. 2. The POS ordering interface 332 depicted in FIG. 3 is one possible POS ordering interfaces of the POS server depicted in FIG. 2. However, the POS ordering interface of the POS server depicted in FIG. 2 is not limited to the embodiment shown in FIG. 3.

In the embodiment depicted in FIG. 3, the POS ordering interface 332, which can be displayed on the touch screen device 212 or other display device, displays touch labels or buttons 338 that correspond to categories of food and beverage items. In the POS ordering interface 332 depicted in FIG. 3, labels/buttons 338-1 through 338-15 correspond to categories of drinks, dishes, staple food and soups. Specifically, labels/buttons 338-1 through 338-5 correspond to drinks, labels/buttons 338-6 through 338-10 correspond to dishes, and labels/buttons 338-11 through 338-15 correspond to staple food and soups. The labels and buttons are arranged according to size, flavor or other characteristic. When an operator (e.g., a waiter or waitress) presses/touches one of the labels/buttons, the touch screen device 212 senses the pressed label/button and sends a signal or message to the processor 214 that informs the processor a selection a corresponding food or beverage item. Based on input received on the touch screen device, the processor can record the entry of a customer's order. In some embodiment, the processor causes the touch screen device to displays an overlay of one or more additional labels/buttons associated with a displayed label/button 338 when the displaced label/button is selected (e.g., pressed). For example, if one of the labels/buttons 338-6 through 338-10 is pressed, the touch screen device may present additional labels/buttons corresponding to small, medium and large drink sizes.

Turning back to FIG. 1, the POS data extractor 120 of the ordering menu generation system 100 can be running in computer hardware separate from the POS server 110 or running as a plug-in in the POS server. In some embodiments, the POS data extractor is configured to retrieve POS item data and ordering history from the POS data that is generated by the POS server for ordering menu generation. In some embodiments, the POS server, the POS database 115 and the POS data extractor forms a POS business system 105, which is located at the premise of a food and/or beverage venue, such as a restaurant, a bar, a food truck, and a food stand.

The POS data collection server 130 of the ordering menu generation system 100 can be running within the same network as the POS business system 105 or in the cloud to receive data from the POS data extractor 120. The POS data collection server can receive data from a single venue or from multiple venues. In some embodiments, the POS data collection server communicates with the POS data extractor through a network 125, which can be any type of computer network or a combination of networks that allows communications between devices connected to the network. Examples of the network may include the Internet, a wide area network (WAN), a local area network (LAN), a storage area network (SAN), a fiber channel network and/or other networks. The network may be configured to support protocols suited for communications with storage arrays, such as Fiber Channel, Internet Small Computer System Interface (iSCSI), Fiber Channel over Ethernet (FCoE) and HyperSCSI.

In some embodiments, the POS data that is received at the POS data collection server 130 is stored in the POS data collection storage 135. Typically, the received POS data includes POS items, items identifiers, and order history. However, depends on POS vendors, the POS data may include more types of data than mentioned earlier.

The intelligent POS menu generation server 140 of the ordering menu generation system 100 is configured to select menu information from POS data and generate an ordering menu for customers. In some embodiments, the intelligent POS menu generation server interprets/processes POS data from the POS data collection storage 135 based on a menu generation policy (e.g., configuration settings from the menu configuration database 170) and creates an ordering menu. The ordering menu can be displayed by a digital display at a food and/or beverage venue, be read or downloaded by a customer through a computing device, or be printed onto different mediums (e.g., paper, fabric, plastic etc.). The ordering menu can be stored in the menu database 155.

The intelligent POS menu generation server 140 can generate customer-facing ordering menus directly from POS data gathered at food and/or beverage venues' POS systems by identifying and remove out-of-date POS items. In some embodiments, the intelligent POS menu generation server cross-references POS historical data, such as POS orders history or payment history. For example, if a POS food and/or beverage item has not been ordered for a certain period of time, the intelligent POS menu generation server can exclude the out of date POS item in the generated ordering menu. Consequently, the intelligent POS menu generation server can help business owners to create up-to-date customer-facing ordering menus directly from POS data. Furthermore, the ordering menu can be generated intelligently by referencing other factors configured ahead of time, such as ordering date, time of the day, special events (e.g., sports event or holiday), numbers of patrons, location of seats (e.g., in bar area or patio or regular tables), by seasons (e.g., summer versus winter) and/or ordering frequency. The intelligent POS menu generation server can also generate ordering menus in which ensures item identifiers are kept the same as specified in a POS system. Consequently, when customers order items from the generated ordering menu, the corresponding item identifier can be passed to the POS server 110 without mismatch. The ordering menu can be periodically generated to avoid any data mismatch since business owners might update their POS data frequently. The generated ordering menu can include codes to track customers' ordering behavior (e.g., Google analytics codes can be embedded in the generated HTML menu pages).

The ordering menu can be created in various forms and/or formats. The ordering menu may be a single file or may include multiple files. For example, the ordering menu may include one or more web pages, one or more PDF files, one or more image files, and/or one or more word processor files (e.g., word files, text files or other types of word processor files). The ordering menu may be presented as texts, graphics (e.g., as an image or multiple images), or a combination of texts and graphics. Texts in an ordering menu may include, for example, a food/beverage item name, a brief description for the food/beverage item, the price for the food/beverage item, and/or available variation of the food/beverage item. A food/beverage item name may include a descriptive name of the item and/or a menu identifier with one or more numbers and/or one or more letters. For example, the item name for a Chinese dish may be Mongolian beef with a menu identifier A1. In another example, the item name for an American food item may be California Burger with a menu identifier No. 1 (#1). The brief description for the food/beverage item may list the ingredients of the item, cooking and/or preparing method of the item, flavors of the item and/or nutrient data and/or calorie information of the item. For example, a brief description for item Mongolian beef may be “beef, onion, and scallion stir-fried with soy source, with rice.” In another example, a brief description for item California Burger may be “juicy beef patties grill over an open fire with onion, tomato, lettuce, California cheese and avocado, served with French fries, 1000 calories.” The price for a particular food/beverage item may include a price for the particular item and/or a price for a combination of items that include the particular item. The available variation of a particular food/beverage item may include information regarding the possible variation of the particular item. For example, the available variation of a food item includes spicy/mild/not spicy, well done/medium/race, organic/non-organic, gluten free/non-gluten free, with flavor agent (e.g., sugar) or without flavor agent.

Each food/beverage item in the ordering menu may be identified by a unique item identifier, which is used in the POS server 110 to identify the food/beverage item. The item identifier for a food/beverage item cannot be modified or changed by a customer that has access to the ordering menu. Consequently, when a customer orders a food/beverage item on the ordering menu, the item identifier is passed back to the POS server for order preparation. For example, a customer may access a webpage-based ordering menu through a computer device such as a personal computer (PC), a laptop computer, a tablet or pad computer, or a Smartphone and click through the ordering menu to order one or more food or beverage items. When a customer selects a certain food or beverage item (e.g., by double-clicking the item on an order webpage), the item identifier for the selected food/beverage item is sent to the POS server 110, which causes the selected food or beverage item be prepared for the customer.

In some embodiments, the intelligent POS menu generation server 140 obtains POS data from at least one food and/or beverage venue, selects a subset of the POS data based on a menu generation policy by the server, and generates the ordering menu for the at least one food and/or beverage venue from the subset of POS data by the server. The menu generation policy may contain information describing how the subset of the POS data is selected from the POS data based on at least one of the date of ordering, time of ordering, location information of ordering, ordering frequency information, event information, weather information, loyalty program information and information regarding number of patrons. In some embodiments, the POS data contains an order history of food and/or beverage items served at at least one food and/or beverage venue, and the ordering menu includes a subset of the food and/or beverage items served at the at least one food and/or beverage venue.

In some embodiments, POS data obtained by the intelligent POS menu generation server 140 contains information regarding food and/or beverage items served at at least one food and/or beverage venue and an order history of the food and/or beverage items. The intelligent POS menu generation server may select a subset of the POS data for the generation of an ordering menu based on the order history and a frequency at which the food and/or beverage items are ordered at at least one food and/or beverage venue. For example, the intelligent POS menu generation server may select the top N (N is a positive integer) of the most frequent ordered food items and/or beverage items to form a chef-recommended ordering menu. The intelligent POS menu generation server may select a subset of the POS data for the generation of an ordering menu based on the order history and a particular date period at which the food and/or beverage items are ordered at the at least one food and/or beverage venue. For example, the intelligent POS menu generation server may select popular food items and/or beverage items ordered last week, last month, or the same month last year to form an ordering menu. The intelligent POS menu generation server may select a subset of the POS data for the generation of an ordering menu based on the order history and a particular time period within a day at which the food and/or beverage items are ordered at at least one food and/or beverage venue. For example, the intelligent POS menu generation server may select popular food items and/or beverage items ordered dawn, morning, noon/midday, afternoon, evening, dusk, night, midnight to form a time-of-the-day ordering menu. The intelligent POS menu generation server may select a subset of the POS data for the generation of an ordering menu based on the order history and a particular location within at least one food and/or beverage venue at which the food and/or beverage items are ordered. For example, the intelligent POS menu generation server may select popular food items and/or beverage items ordered at the bar area, at patio area or at regular tables to form a bar ordering menu, a patio ordering menu, and a regular ordering menu, respectively. The intelligent POS menu generation server may select a subset of the POS data for the generation of an ordering menu based on the order history and an event surrounding which the food and/or beverage items are ordered at at least one food and/or beverage venue. For example, the intelligent POS menu generation server may select popular food items and/or beverage items ordered at a sports event or a holiday to form a sports event ordering menu or a holiday ordering menu. The intelligent POS menu generation server may select a subset of the POS data for the generation of an ordering menu based on the order history and a particular weather condition under which the food and/or beverage items are ordered at at least one food and/or beverage venue. For example, the intelligent POS menu generation server may select popular food items and/or beverage items ordered at winter, summer, cold days or hot days to form a weather-specific menu. The intelligent POS menu generation server may select a subset of the POS data for the generation of an ordering menu based on the order history and a particular number of patrons that order at least one of the food and/or beverage items at at least one food and/or beverage venue. For example, the intelligent POS menu generation server may select popular food items and/or beverage items ordered by groups to form a family menu for large family gatherings. The intelligent POS menu generation server may select a subset of the POS data for the generation of an ordering menu based on the order history and a loyalty program record of patrons that order at least one of the food and/or beverage items at at least one food and/or beverage venue. For example, the intelligent POS menu generation server may select popular food items and/or beverage items ordered by customers participating in loyalty programs to form a special Thank-You menu. The intelligent POS menu generation server may select a subset of the POS data for the generation of an ordering menu based on the order history and age or gender information of patrons that order at least one of the food and/or beverage items at at least one food and/or beverage venue. For example, the intelligent POS menu generation server may select popular food items and/or beverage items ordered by female customers to form a special for-women menu. The intelligent POS menu generation server may select the subset of the POS data based on the menu generation policy and a trend at which the food and/or beverage items are ordered at at least one food and/or beverage venue. For example, the intelligent POS menu generation server may detect a trend of ordering (e.g., detect that the number/percentage of orders for a certain item and/or a certain category of items is increasing or decreasing, detect that the number/percentage of a certain group of customers increasing or decreasing, detect that a certain combination of orders is increasing or decreasing.) In an example, the intelligent POS menu generation server detects that the number/percentage of orders for a dish and/or a certain category of dishes (spicy dishes) is increasing or decreasing. In an example, the intelligent POS menu generation server detects that the number/percentage of young/old, female/male, individual/family customers increasing or decreasing. In an example, the intelligent POS menu generation server detects that a certain combination of drinks is increasing or decreasing.

The menu server 150 of the ordering menu generation system 100 is configured to host ordering menus stored in the menu database 155 and to deliver/transmit an ordering menu a client device 160. In some embodiments, the menu server is a web server that can host webpages, documents, images, and/or videos. The client device may have a wide range of mobility and portability. In an embodiment, the client device is a handheld mobile device such as a cellular phone, a Smartphone, a Personal Digital Assistant (PDA), an Enterprise digital assistant (EDA), or a handheld gaming device. In another embodiment, the client device is a portable computing device such as a laptop computer, a net book computer, or a tablet computer. For example, the client device may be a Smartphone or tablet that remotely accesses an ordering menu through an Application (APP). The client device may support at least one of various RF communications protocols, including without limitation, Bluetooth, ZigBee, Institute of Electrical and Electronics Engineers (IEEE) 802.11 wireless local area network (WLAN), HiperLAN (High Performance Radio LAN), Global System for Mobile communications (GSM), Universal Mobile Telecommunications System (UMTS), Code Division Multiple Access (CDMA), Worldwide Interoperability for Microwave Access (WiMax) and other communications protocols as defined by the 3rd Generation Partnership Project (3GPP), the 3rd Generation Partnership Project 2 (3GPP2), and 4G Long Term Evolution (LTE) standards bodies. The menu server may transmit an ordering menu to the client device upon a request from the client device. In other embodiments, the menu server identifies the client device as a potential advertising target and transmits an ordering menu to the client device without receiving a request from the client. In some embodiments, the menu server includes a printing device, which can print an ordering menu and/or prepare a leaflet with an ordering menu or a mailing package with an ordering menu to be mailed or delivered.

The POS database 115, the POS data collection storage 135, the menu generation configuration database 170 and/or the menu database 155 can be any type of storage devices, such as memory, cache, solid-state devices (SSDs), hard disks or a combination of the above. In some embodiments, at least one of these storage devices may be local storage devices of a computer, e.g., a locally attached disk or an SSD within a computer. The storage devices may operate as components of a network-attached storage (NAS) and/or a storage area network (SAN).

In some embodiments, an ordering menu that is generated by the intelligent POS menu generation server 140 can be further enhanced automatically or manually to present a more informative menu to patrons. For example, one or more images, titles, description or user interface specific information can be added onto an ordering menu.

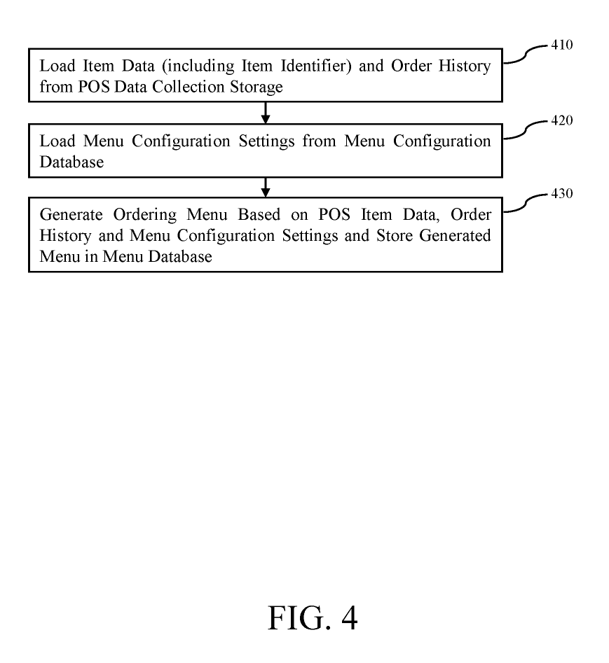

FIG. 4 is a flow chart that illustrates an exemplary operation of the intelligent POS menu generation server 140 depicted in FIG. 1. In the exemplary operation, the intelligent POS menu generation server processes POS data and generate an ordering menu based on a menu generation policy (e.g., configuration settings stored at the menu configuration database 170). The intelligent POS menu generation server may execute a specific menu generation algorithm to generate the ordering menu.

At step 410, item data (including item identifier) and POS order history are loaded into the intelligent POS menu generation server 140 from the POS data collection storage 135. The POS data may be temporarily stored in a memory device or a cache of the intelligent POS menu generation server. At step 420, a menu generation policy (e.g., menu configuration information) is loaded into the intelligent POS menu generation server from the menu configuration database 170. The configuration setting specified in the menu configuration database may indicate which items of the POS data that are converted into menu items. At step 430, the intelligent POS menu generation server creates an ordering menu according to the menu configuration information and stores the ordering menu in the menu database 155. The menu configuration information may specify that only POS items of the POS data that are within a specific time range to be included in the ordering menu. The intelligent POS menu generation server checks the POS order history to identify which food and/or beverage item(s) has/have an ordering record in the specific time range and includes the identified item or items in the ordering menu. The specific time range may be a range of time between a previous time point (e.g., 1 week ago, 1 month ago, a certain number of months ago, a year ago, a number of years ago, etc.) and the present or a range of time between different previous time points (e.g., last January, last Christmas week, etc.). For example, the menu configuration information may specify that only food and/or beverage items that have been ordered in the last 180 days to be included in the ordering menu. The intelligent POS menu generation server checks the POS order history to identify which food and/or beverage item(s) has/have an ordering record in the past 180 days and includes the identified item or items in the ordering menu. In some embodiments, in order to generate a special event ordering menu, the menu configuration information may specify that only food and/or beverage items that have been ordered in a time range surrounding a previous event to be included in the special event ordering menu. An event may be a holiday (e.g., Christmas, Thanksgiving, Independence day etc.,) a sports event (e.g., a professional sports event such as a professional football game, a professional basketball game, a professional baseball game, a college football game, a college basketball game), a political event (e.g., an election day), or any other type of event. The intelligent POS menu generation server checks the POS order history to identify which food and/or beverage item(s) has/have an ordering record in the time range surrounding the event and includes the identified item or items in the ordering menu. For example, in order to generate a holiday ordering menu, the menu configuration information may specify that only food and/or beverage items that have been ordered in the week/weeks surrounding a certain holiday (e.g., Christmas, Thanksgiving, etc.,) to be included in the holiday ordering menu.

After the ordering menu is created and stored in the menu database 155, item records in the ordering menu may be enhanced manually by an operator or automatically according to a specific enhancement algorithm before being presented to the customer. For example, one or more images may be uploaded to the menu database and integrated with an ordering menu such that an updated ordering menu has user-friendly pictures for customers to view. In another example, a user-friendly title and/or an item description may be entered for a food or beverage item as names of items in the POS server 110 usually use abbreviations, which are not easily understood. Enhancement operations for ordering menu can be performed by the intelligent POS menu generation server 140, the menu server 150 and/or other suitable computing devices. After the optional enhancement operations, the ordering menu is ready for customers to access/view via electronic devices or printed mediums.

Examples of operations of the intelligent POS menu generation server 140 are described as follows. Typically, POS systems, such as the POS server 110, store at least two types of POS data: items and transactions (order histories). Some examples of POS items and POS order histories are presented in Table-I and Table-II, respectively.

TABLE I
POS Item Data

| ItemId | ItemName | ItemPrice | Currency | Type |
|---|---|---|---|---|
| 1 | abc | 10.00 | USD | veggie |
| 2 | xyz | 15.00 | USD | drink |
| 3 | cde | 25.00 | USD | combo |

TABLE II
POS Order Histories

| Date | Time | ItemId | Payment | Location | Dinning |
|---|---|---|---|---|---|
| Nov. 2, 2014 | 10:35 AM | 1 | Cash | zone1 | to go |
| Nov. 3, 2014 | 11:34 AM | 2 | CC | zone2 | for here |

Table_I shows three different food and/or beverage items. Specifically, Tabel_I shows item 1, which is a vegetable dish with an item name of “abc,” and a price of 10 dollars, item 2, which is a drink with an item name of “xyz,” and a price of 15 dollars, and item 3, which is a combination plate (e.g., a dish plus a drink) with an item name of “abc,” and a price of 25 dollars. Table_II shows a transaction record on 11/02/2014 at 10:35 am, for item 1, which is paid for in cash as a to-go item and takes place at zone 1 and a transaction record on 11/03/2014 at 11:34 am, for item 2, which is paid for in credit card as a dine-in item and takes place at zone 2. The location information specified in POS data is the relative location with a restaurant or other food business. Locations within a restaurant or other food business can be divided into zones or sections. For example, zone1 can be used to refer to the main lobby (regular tables) of a restaurant while zone2 can be used to refer to a bar within the restaurant.

In some embodiments, the intelligent POS menu generation server 140 refers to or checks POS order histories (e.g., Table_II Order histories) to avoid an item that does not have any transaction record or does not have any transaction record in a specific time range, such as recent N (N being a positive integer) days where N can be configurable. For example, item 3 (with item name cde) does not have a transaction record. Consequently, the intelligent POS menu generation server does not include item 3 in an ordering menu.

In some embodiments, the intelligent POS menu generation server 140 refers to or checks POS order histories (e.g., Table_II Order histories) to generate a time specific ordering menu. For example, if item 1 has been ordered more frequently on Monday than other POS items, the intelligent POS menu generation server creates a Monday's ordering menu, which lists item 1 before or in front of other items in the Monday's ordering menu.

In some embodiments, the intelligent POS menu generation server 140 refers to or checks POS order histories (e.g., Table_II Order histories) to generate a location specific ordering menu. For example, if item1 has been ordered more frequently than other items in zone1, the intelligent POS menu generation server creates an ordering menu for zone1, which lists item 1 before or in front of other items in the ordering menu for zone1.

In some embodiments, the intelligent POS menu generation server 140 refers to or checks POS order histories (e.g., Table_II Order histories) to generate a to-go ordering menu that contains food and/or beverage items ordered to go more frequently than other items. For example, the intelligent POS menu generation server may check the frequencies of to-go items ordered with a specific time range (e.g., within a month, within a few months, or with a year) and include only to-go items with a frequency that is higher than a threshold in an ordering menu or items with highest frequencies (e.g., top 5 most ordered to-go items, top 10 most ordered to-go items).

In some embodiments, the intelligent POS menu generation server 140 checks weather and temperature data to generate the most relevant menu. For example, the intelligent POS menu generation server generates an ordering menu for a cold date, which shows hot drinks in front of or before cold drinks.

In some embodiments, after POS data is collected from multiple restaurants, the intelligent POS menu generation server 140 uses a machine learning algorithm to find similarity between the restaurants. For a customer who likes a certain local restaurant, he/she can find a similar restaurant that offers similar dishes as that local restaurant when he/she travels to a remote location, based on the findings of restaurant similarities. For restaurant owners, they can be acquainted with each other based on similar dishes, exchange experience, and/or form a social network for restaurants. The intelligent POS menu generation server can also ensure that similar restaurants within driving distance do not have identical or similar ordering menus to reduce competition between business owners.

Because most of the item names in POS are specified as abbreviations, it is necessary to have “enhancement activity” to specify the complete item name in an ordering menu. Other enhancements, such as attaching item pictures for corresponding items, can also be done to generate an informative ordering menu for customers. In some embodiments, the intelligent POS menu generation server 140 executes an algorithm to automatically recommend an informative item name and one or more pictures for an item in an ordering menu. In some embodiment, the intelligent POS menu generation server 140 uses an algorithm to learn enhancement operations/activities with a pre-defined dictionary as well as uses machine learning techniques to learn enhancement operations/activities from different users/food businesses. For example, an abbreviation such as “gen chicken” can be possible named as “general's chicken” as this abbreviation-item name mapping has been previously specified in other enhancement activities for different food businesses. In some embodiments, the intelligent POS menu generation server performs the learning process based on a text analysis machine learning algorithm to group similar names and provides mapped names as recommendations.

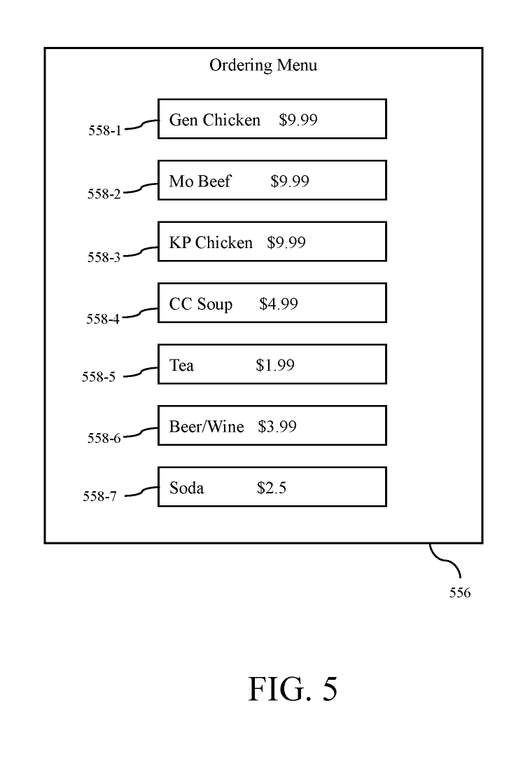

FIG. 5 depicts an example of an ordering menu 556 that is generated by the intelligent POS menu generation server 140. As shown in FIG. 5, the ordering menu includes seven food and beverage entries 558-1-558-7. Specially, the ordering menu includes a first entry 558-1 of “Gen Chicken $9.99,” a second entry 558-2 of “Mo Beef $9.99,” a third entry 558-3 of “KP chicken $9.99,” a fourth entry 558-4 of “CC Soup $4.99,” a fifth entry 558-5 of “Tea $1.99,” a sixth entry 558-6 of “Beer/Wine $3.99,” and a seventh entry 558-7 of “Soda $2.5.”

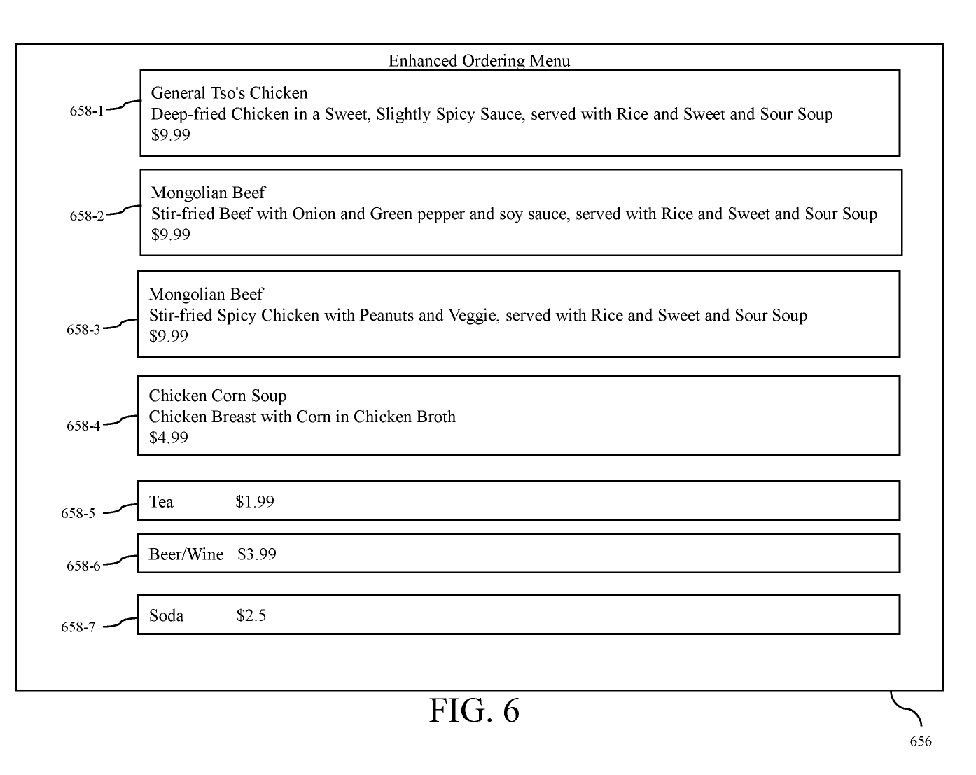

FIG. 6 depicts an example of the ordering menu 556 after enhancement operations by the intelligent POS menu generation server 140. The intelligent POS menu generation server replaces abbreviations of food and beverage items with complete and informative names and provides a brief description for all of the food items. The intelligent POS menu generation server can use previously found mappings between item abbreviations and item full names and food item description from a database or from previous learning results. As shown in FIG. 6, an enhanced ordering menu 656 includes seven enhanced food and beverage entries 658-1-658-7. Entries 558-1, 558-2, 558-3, 558-4 are updated with entries 658-1, 658-2, 658-3, 658-4 containing full and informative names and brief description for the food items. For example, an abbreviation “Gen Chicken” is replaced by a full name “General Tso's Chicken” and a brief description “Deep-fried Chicken in a Sweet, Slightly Spicy Sauce, served with Rice and Sweet and Sour Soup.” In addition, entries 558-5, 558-6, 558-7 are updated with entries 658-1, 658-2, 658-3, 658-4 that match the format (e.g., size) of entries 658-1, 658-2, 658-3, 658-4.

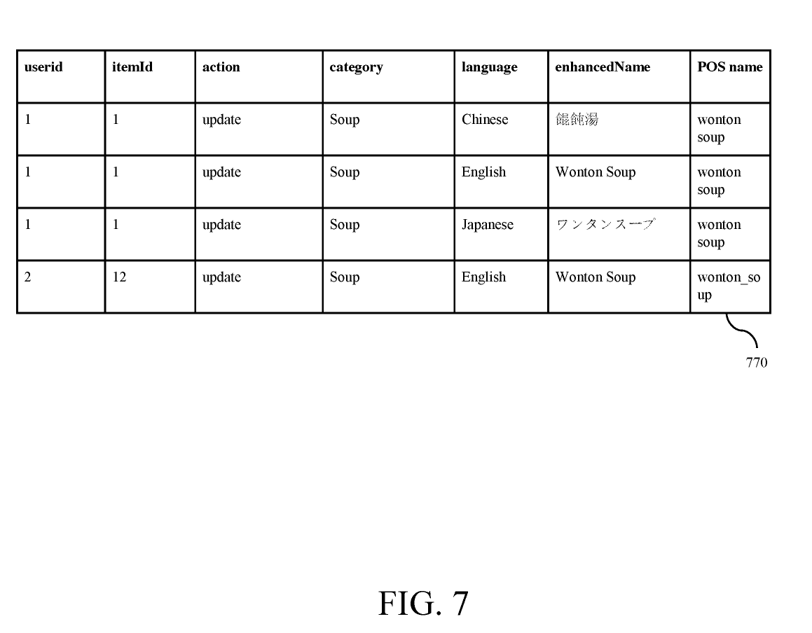

FIG. 7 depicts a result data set 770 of an example enhancement operation. As shown in FIG. 7, an item name (e.g., wonton soup) can be translated into different languages (e.g., into Chinese and Japanese) by the intelligent POS menu generation server since the algorithm executed by the intelligent POS menu generation server can learn from previous enhancement activities. An enhanced ordering menu with different languages can help customers who speak different languages to order items easily, reduce possible confusion by waiter/waitress staff and to improve order speed.

Fast food restaurants with kiosk services can benefit from techniques described above. For example, the menu displayed on a kiosk can be generated based on the transaction history stored in POS so that a machine learning algorithm executed by the intelligent POS menu generation server 140 can identify the most popular items in past history based on several similar criteria described above. This will benefit the kiosk operation in turns of ordering performance since the customers can make decisions much faster because popular items are shown in the most visible user interface (UI) areas.

Techniques described above can be also applied to food and dinning services with various locations, such as food trucks and mobile vending machines. The location factors can be used in a machine learning algorithm executed by the intelligent POS menu generation server 140 such that a food ordering menu can be generated differently in different locations and the most popular items in the past history are shown in the most visible UI areas.

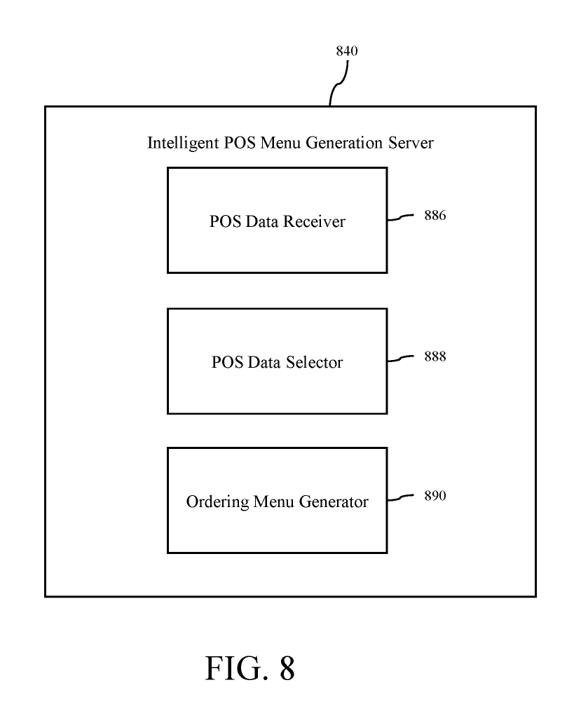

Turning now to FIG. 8, a block diagram of components of the intelligent POS menu generation server 140 depicted in FIG. 1 in accordance with an embodiment of the invention is shown. As illustrated in FIG. 8, an intelligent POS menu generation server 840 includes a POS data receiver 886, a POS data selector 888 and an ordering menu generator 890. These components of the intelligent POS menu generation server can be implemented as software, hardware or a combination of software and hardware.

In an example operation of the intelligent POS menu generation server 840 depicted in FIG. 8, the POS data receiver 886 is configured to obtain the POS data from at least one food and/or beverage venue by a server. The POS data selector 888 is configured to select a subset of the POS data based on a menu generation policy by the server. The ordering menu generator 890 is configured to generate the ordering menu for the at least one food and/or beverage venue from the subset of POS data by the server.

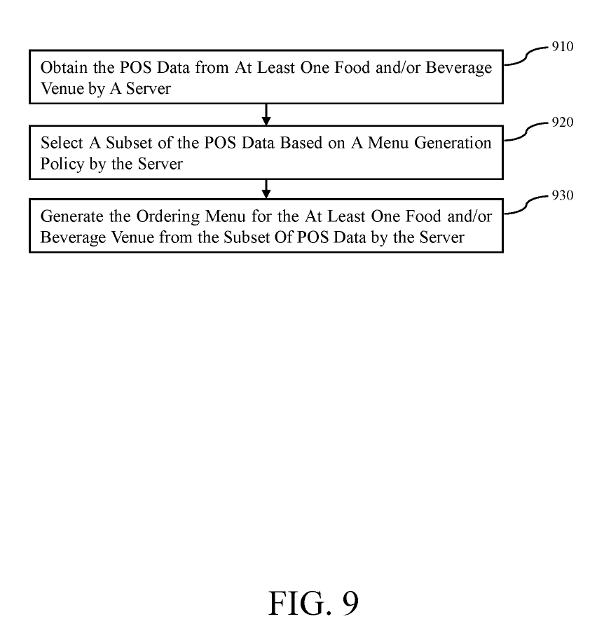

A method for creating an ordering menu for food and/or beverage items from POS data in accordance with an embodiment of the invention is described with reference to a flow diagram of FIG. 9. At block 902, the POS data is obtained from at least one food and/or beverage venue by a server. At block 904, a subset of the POS data is selected based on a menu generation policy by the server. At block 906, the ordering menu is generated for the at least one food and/or beverage venue from the subset of POS data by the server.

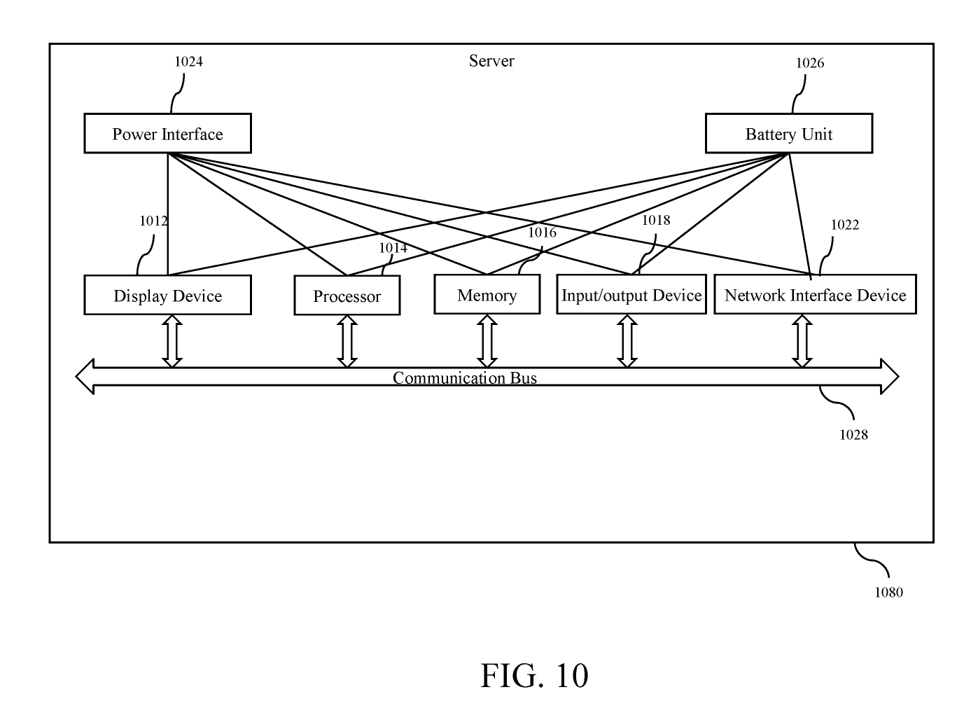

FIG. 10 depicts an embodiment of a server 1080. The server 1080 depicted in FIG. 10 is one possible embodiment of the intelligent POS menu generation server 140 and/or the menu server 150 depicted in FIG. 1. However, the intelligent POS menu generation server and the menu server depicted in FIG. 1 are not limited to the embodiment shown in FIG. 10. In the embodiment depicted in FIG. 10, the server 1080 includes an optional display device 1012, a processor 1014, memory 1016, an input/output device 1018, a network interface 1022, a power interface 1024 and an optional battery unit 1026. The processor is configured to execute computer programs to implement an algorithm, e.g., to generate ordering menus. The memory is configured to store the inputs to the server. The input/output device is configured to receive input and to output generated results. In an embodiment, the input/output device includes a print device configured to print documents generated by the server, such as ordering menus. The network interface device is configured to provide a wired communication interface and/or a wireless communication interface for the server. The power interface, which may be an Alternating Current (AC) power interface, is used to supply power to the server. The battery unit, which may be any suitable type of battery unit (e.g., one or more alkaline batteries and lithium-ion batteries), may be used to supply backup power to the server. In the embodiment depicted in FIG. 10, the display device, the processor, the memory, the printing device and the network interface are all connected to a communication bus 1028, which facilitates communications between these connected devices. In some embodiments, at least some of the display device, the processor, the memory, the printing device and the network interface are not connected to the communication bus and communicate with other component of the server through other communication connections.

It should be noted that although the techniques are described with respect to food and beverage ordering, these techniques can be used in retail stores which use POS systems.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid-state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method of creating an ordering menu for food and/or beverage items from point of sale (POS) data, the method comprising:
obtaining the POS data from at least one food and/or beverage venue by a server;
selecting a subset of the POS data based on a menu generation policy by the server; and
generating the ordering menu for the at least one food and/or beverage venue from the subset of POS data by the server.

2. The method of claim 1, wherein the menu generation policy contains information describing how the subset of the POS data is selected from the POS data based on at least one of date of ordering, time of ordering, location information of ordering, ordering frequency information, event information, weather information, loyalty program information and information regarding number of patrons.

3. The method of claim 1, wherein the POS data contains information regarding a plurality of food and/or beverage items served at the at least one food and/or beverage venue and an order history of the food and/or beverage items.

4. The method of claim 3, wherein selecting the subset of the POS data based on the menu generation policy comprises selecting the subset of the POS data based on the order history and a frequency at which the food and/or beverage items are ordered at the at least one food and/or beverage venue.

5. The method of claim 3, wherein selecting the subset of the POS data based on the menu generation policy comprises selecting the subset of the POS data based on the order history and a particular date period at which the food and/or beverage items are ordered at the at least one food and/or beverage venue.

6. The method of claim 3, wherein selecting the subset of the POS data based on the menu generation policy comprises selecting the subset of the POS data based on the order history and a particular time period within a day at which the food and/or beverage items are ordered at the at least one food and/or beverage venue.

7. The method of claim 3, wherein selecting the subset of the POS data based on the menu generation policy comprises selecting the subset of the POS data based on the order history and a particular location within the at least one food and/or beverage venue at which the food and/or beverage items are ordered.

8. The method of claim 3, wherein selecting the subset of the POS data based on the menu generation policy comprises selecting the subset of the POS data based on the order history and an event surrounding which the food and/or beverage items are ordered at the at least one food and/or beverage venue, and wherein the event comprises one of a holiday and a sports event.

9. The method of claim 3, wherein selecting the subset of the POS data based on the menu generation policy comprises selecting the subset of the POS data based on the order history and a trend at which the food and/or beverage items are ordered at the at least one food and/or beverage venue.

10. The method of claim 3, wherein selecting the subset of the POS data based on the menu generation policy comprises selecting the subset of the POS data based on the order history and a particular weather condition under which the food and/or beverage items are ordered at the at least one food and/or beverage venue.

11. The method of claim 3, wherein selecting the subset of the POS data based on the menu generation policy comprises selecting the subset of the POS data based on the order history and a particular number of patrons that order at least one of the food and/or beverage items at the at least one food and/or beverage venue.

12. The method of claim 3, wherein selecting the subset of the POS data based on the menu generation policy comprises selecting the subset of the POS data based on the order history and a loyalty program record of patrons that order at least one of the food and/or beverage items at the at least one food and/or beverage venue.

13. The method of claim 3, wherein selecting the subset of the POS data based on the menu generation policy comprises selecting the subset of the POS data based on the order history and age or gender information of patrons that order at least one of the food and/or beverage items at the at least one food and/or beverage venue.

14. The method of claim 3, wherein the information regarding the food and/or beverage items served at the at least one food and/or beverage venue comprises item identifiers of the food and/or beverage items served at the at least one food and/or beverage venue, and wherein the ordering menu comprises a subset of the food and/or beverage items served at the at least one food and/or beverage venue with the corresponding item identifiers.

15. The method of claim 1, wherein the POS data contains an order history of a plurality of food and/or beverage items served at the at least one food and/or beverage venue, and wherein the ordering menu comprises a subset of the food and/or beverage items served at the at least one food and/or beverage venue.

16. The method of claim 1, further comprising performing a menu enhancement operation on the ordering menu, and performing the menu enhancement operation on the ordering menu comprises adding one of an image, a name and description information to a food and/or beverage item of the ordering menu.

17. The method of claim 1, further comprising embedding a tracking code within the ordering menu.

18. The method of claim 1, wherein the ordering menu is in digital form or in paper form.

19. A system of creating an ordering menu for food and/or beverage items from point of sale (POS) data, the system comprising:
a POS data receiver configured to obtain the POS data from at least one food and/or beverage venue by a server;
a POS data selector configured to select a subset of the POS data based on a menu generation policy by the server; and
an ordering menu generator configured to generate the ordering menu for the at least one food and/or beverage venue from the subset of POS data by the server.

20. A computer-readable storage medium containing program instructions for creating an ordering menu for food and/or beverage items from point of sale (POS) data, wherein execution of the program instructions by one or more processors causes the one or more processors to perform steps comprising:
obtaining the POS data from at least one food and/or beverage venue by a server;
selecting a subset of the POS data based on a menu generation policy by the server; and
generating the ordering menu for the at least one food and/or beverage venue from the subset of POS data by the server.
